(19) United States
(12) Patent Application Publication
(10) Pub. No.: US 2016/0328720 A1
(43) Pub. Date: Nov. 10, 2016

(54) MAINTAINING THE TRANSFER OF DATA IN A SALES LEAD ENVIRONMENT

(71) Applicant: Underground Elephant, San Diego, CA (US)

(72) Inventors: Jason Kulpa, San Diego, CA (US); Keola Malone, San Diego, CA (US); Jovel Lacson, Chula Vista, CA (US); Kevin Mccarroll, San Diego, CA (US); Aaron Scherer, San Diego, CA (US)

(21) Appl. No.: 14/974,742

(22) Filed: Dec. 18, 2015

Related U.S. Application Data
(60) Provisional application No. 62/158,471, filed on May 7, 2015.

(51) Int. Cl. G06Q 30/02

(52) U.S. Cl. CPC G06Q 30/0201

(57) ABSTRACT

A client portal for facilitating the formation and tracking of sales campaigns. Client information, containing client attributes, may be received by the client portal through a graphical user interface. The client information may be normalized. Sales campaigns may be formed that have attributes including: client information, sales-lead types and/or other attributes. Campaign rules may be associated with the campaigns that apply to the sales leads to be associated with the sales campaign. Such rules may include type or geographic area restrictions. Sales leads may be monitored to determine conversion information associated with the sales leads and/or the sales campaigns to facilitate optimization of the sales campaigns.

### CROSS-REFERENCE TO RELATED APPLICATIONS

This application claims priority to and the benefit of U.S. Provisional Patent Application No. 62/158,471, filed on May 7, 2015, and titled “A Portal to Manage Sales Campaigns for Sales Lead Clients,” which is incorporated herein by reference in its entirety.

### TECHNICAL FIELD

The subject matter described herein relates to a maintaining the transfer of data in a sales lead environment.

### BACKGROUND

In marketing, lead generation is the generation of consumer interest or inquiry into products or services of a business. Leads can be created for purposes such as list building, e-newsletter list acquisition or for sales leads.

Sales leads can be generated online through user interactions with online lead generation sources. The information obtained by online lead generation sources includes Internet-specific data that can yield valuable information and performance enhancements in a sales lead management environment.

### SUMMARY

In one aspect, the present disclosure relates to a method of providing a client portal to clients for the purpose of managing the generation of sales leads. The method can be performed by at least one data processor forming at least part of a computing system. The method may comprise one or more operations. The operations can include receiving, by the at least one data processor, client information. The client information can be received via a graphical user interface. The client information can include one or more client attributes associated with one or more sales leads. Normalizing rules can be executed by the at least one data processor. The normalizing rules can be executed on the received client information to modify the received client information into a format readable by a sales campaign computing system configured to generate a sales campaign for a client associated with the client information.

Formation of one or more sales campaigns for the client can be facilitated. Each of the sales campaigns can include the client information, one or more campaign attributes associated with the one or more sales leads, each of the one or more sales leads belonging to one or more sales lead types, one or more campaign rules for associating sales leads with at least one of the one or more sales campaigns, or the like. The one or more sales leads can be associated with the one or more sales campaigns for the client according to the one or more campaign rules.

A graphical representation of the one or more sales campaigns can be generated for presentation to the client through a display device associated with the client.

In some variations, the one or more campaign rules can dictate the types of sales leads associated with the campaign, geographical restrictions on the location of sales leads associated with the campaign, or the like.

In some variations, the method may comprise logging, by the at least one data processor, changes to individual ones of the one or more sales campaigns. Sales leads associated with individual ones of the one or more sales campaigns that accept offers from the client can be monitored. Generation of a graphical presentation may be facilitated. The graphical presentation can be provided on a graphical user interface. The graphical presentation can include the proportion of sales leads associated with individual ones of the one or more sales campaigns that have accepted offers from the client.

Individual ones of the one or more sales campaigns can include one or more performance parameters. The performance of individual ones of the one or more sales campaigns can be compared to the one or more performance parameters to provide an indication of the sales campaign's performance. A graphical presentation on a graphical user interface can be generated. The graphical presentation can include an indication of the performance of individual ones of the one or more sales campaigns compared to the one or more performance parameters.

The one or more sales campaign attributes can include an indication of one or more separate products offered by the client.

Forming an individual one of the one or more sales campaigns for the client can include facilitating presentation of a graphical user interface providing an indication of one or more potential campaign attributes associated with the sales campaign. Selection and/or entry of the one or more potential campaign attributes for inclusion in the sales campaign can be facilitated. Selection and/or entry can be performed by a user via a graphical user interface. In some variations, sales leads having sales lead attributes matching the selected and/or entered sales campaign attributes can be selected for the sales campaign.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more implementations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to client-server architecture and other system types, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram of a system having one or more features consistent with implementations of the current subject matter;

FIG. 2 is a process flow diagram illustrating aspects of a method having one or more features consistent with implementations of the current subject matter;

FIG. 3 is a diagram illustrating aspects of a system showing features consistent with implementations of the current subject matter;

FIG. 4 is an illustration of an example of a graphical user interface configured to facilitate the formation of the one or more sales campaigns on a system having one or more features consistent with implementations of the current subject matter;

FIG. 5 is an illustration of a graphical user interface configured to facilitate the entry of one or more campaign attributes on a system having one or more features consistent with implementations of the current subject matter;

FIG. 6 is an illustration of a graphical user interface configured to facilitate the mapping of sales leads to delivery options by a client using a system having one or more features consistent with implementations of the current subject matter;

FIG. 7 is an illustration of a sales campaign change log on a system having one or more features consistent with implementations of the current subject matter;

FIG. 8 is an illustration of a graphical user interface configured to facilitate, by a client, the placement of an order for sales leads associated with one or more previously formed sales campaigns on a system having one or more features consistent with implementations of the current subject matter;

FIG. 9 is an illustration of a report of one or more key performance indicators associated with one or more sales campaigns generated by a system having one or more features consistent with implementations of the current subject matter; and,

FIG. 10 is an illustration of a report of one or more key performance indicators associated with one or more sales campaigns generated by a system having one or more features consistent with implementations of the current subject matter.

### DETAILED DESCRIPTION

The present disclosure relates to a lead generation computing system configured to provide a graphical user interface for facilitating the creation and management of sales lead generation campaigns. The client portal can be configured to provide account representatives of a client and/or a client portal provider the ability to manage one or more elements of relationships with sales lead clients. The client portal can be configured to facilitate the integration of account manager activities, client activities, and/or portal provider activities to provide a homogenized multi-sector system for a sales lead environment, improving the efficiency of the underlying system.

Lead clients may be those clients that are desirous of receiving sales leads for one or more products. In some implementations, the client portal may be configured to provide a web interface through which lead clients and/or aspects of the lead client's relationship with the client portal provider may be managed. The client portal may be configured to facilitate the provision of sales leads to sales lead clients. The client portal may be configured to facilitate the entry and/or selection of one or more parameters associated with the sales leads, to filter the sales leads, for individual clients. In some implementations, each lead client may provide a specific set of filters, integration specifications, lead categories, and other filters. In some implementations the client portal may be configured to normalize all of the data associated with managing lead clients into a manageable location(s) and with known manageable format(s).

Lead clients may have varying degrees of permissions to visibility into sales lead information. Lead clients may have permission to see at least some of the sales lead information for one cohort of sales lead information but not another. The client portal can be configured to integrate a lead client's set of permissions with the client information types to ensure that each lead client obtains access to the information to which they are privileged to access and prevent access to the information to which they are barred from accessing.

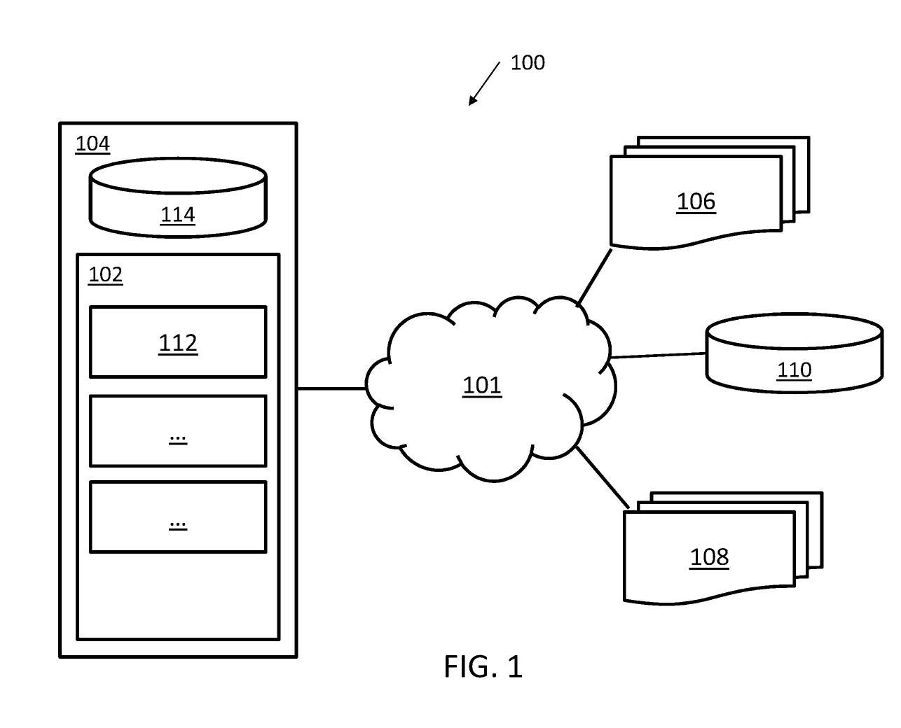

FIG. 1 is an illustration of a system 100 for providing a client portal. The system 100 may comprise one or more physical processors 102. The system may include communication lines between various elements of the system to enable the exchange of information with a network and/or other computing platforms. Such communication lines may include a network 101. The network 101 may be, for example, the Internet. The processors 102 may be configured to execute computer program instructions. The processors 102 may be configured to execute the computer program instructions via one or more of hardware, software, and/or firmware. Although system 100 may be described in certain sections herein as including a server 104, this is not intended to be limiting. The functionality attributable to server 104 may be attributable to multiple servers and/or other components of system 100. For example, some of the functionality herein described may be performed by client computing devices 106, third-party computing devices 108, third-party electronic storage providers 110, and/or other computer devices.

A given client computing device 106 may include one or more processors configured to execute computer program instructions. The computer program instructions may be configured to enable an expert or user associated with the given client computing device 106 to interface with system 100 and/or external resources 108, third-party storage devices 110, and/or provide other functionality attributed herein to client computing device 106. By way of non-limiting example, the given client computing platform 106 may include one or more of a desktop computer, a laptop computer, a handheld computer, a tablet computing device, a NetBook, a Smartphone, a gaming console, a client-side server and/or other computing devises.

The processor(s) 102 may be configured to execute computer program instructions, such as computer program instructions 112. Computer program instructions 112 are represented here as discrete blocks within processor 102, but this is not intended to be limiting. The discrete blocks for computer program instructions 112 is provided in FIG. 1 for ease of representation only, and the present disclosure contemplates any format or arrangement of computer program instructions 112. The functionality described herein may be provided by discrete computer program modules and/or components, or may be provided by continuous uninterrupted code, or by any other arrangement of computer program instructions. The computer program instructions 112 may be stored in electronic storage media. The computer program instructions 112 may be stored in electronic storage media 114 associated with server 104 in which at least one or more of the processors 102 reside. The computer program instructions 112 may be stored in external storage 110. In some of the implementations, the computer program instructions 112 for providing a client portal to clients may be stored on client computing devices 106 associated with the clients.

The external resources 108 may include sources of information, cross-referencing services, fact checking services and/or other services that are provided by external entities participating with system 100, and/or other resources. In some implementations, some or all of the functionality attributed herein to external resources 108 may be provided by resources included in system 100.

Electronic storage 114 and/or electronic storage 110 may comprise electronic storage media that electronically stores information. The electronic storage media of electronic storage 114 may include one or both of system storage that is provided integrally (i.e., substantially non-removable) with server 104 and/or removable storage that is removably connectable to server 104 via, for example, a port (e.g., a USB port, a firewire port, etc.) or a drive (e.g., a disk drive, etc.). Electronic storage 114 may be associated with client computing devices 10. Electronic storage 110/114 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 110/114 may include one or more virtual storage resources (e.g., cloud storage, a virtual private network, and/or other virtual storage resources). Electronic storage 110/114 may store software algorithms, information determined by processor 102, information received from server 104, information received from client computing devices 106, information received from external resources 108 and/or other information that enables server 104 to function as described herein.

Processor(s) 102 is configured to provide information processing capabilities in server 100. As such, processor 102 may include one or more of a digital processor, an analog processor, a digital circuit designed to process information, an analog circuit designed to process information, a state machine, and/or other mechanisms for electronically processing information. Although processor 102 is shown in FIG. 1 as a single entity, this is for illustrative purposes only. In some implementations, processor 102 may include a plurality of processing units. These processing units may be physically located within the same device, or processor 102 may represent processing functionality of a plurality of devices operating in coordination.

The client portal system 100 may facilitate the generation of custom functionality for each client. Custom functionality for each client may include custom sales lead filters, custom lead filters based on lead attributes, custom sales campaigns to generate sales leads, filtering based on traffic sources or traffic types, filtering custom web properties with content pertaining to client needs, intraday scheduling of lead delivery times, the ability to deliver leads in accordance with client specifications, ability to restrict leads by geographic area, ability to set lead demand by day, week, or month, and/or other filters. The client portal may facilitate a client opening up multiple lead buys to segregate leads by type, and group different lead buys together to coordinate delivery throughout. Information obtained by the client portal may be stored in a client portal database. The client portal database may be stored in electronic storage 110/114. The database may be designed to handle and/or encompass any custom filter, logic, or distribution rule associated with client. In some implementations, the client portal software may be logically disposed atop the client-portal database. In other implementations, the client portal software may be logically disposed away from the client-portal database. The client portal may be configured in such a manner to facilitate the creation of complex integration system by non-technical users. In some implementations, the client portal may be configured to facilitate access to the client portal by clients. The client portal may be configured to facilitate uploading of lead disposition data, view order details, and change basic order settings by clients.

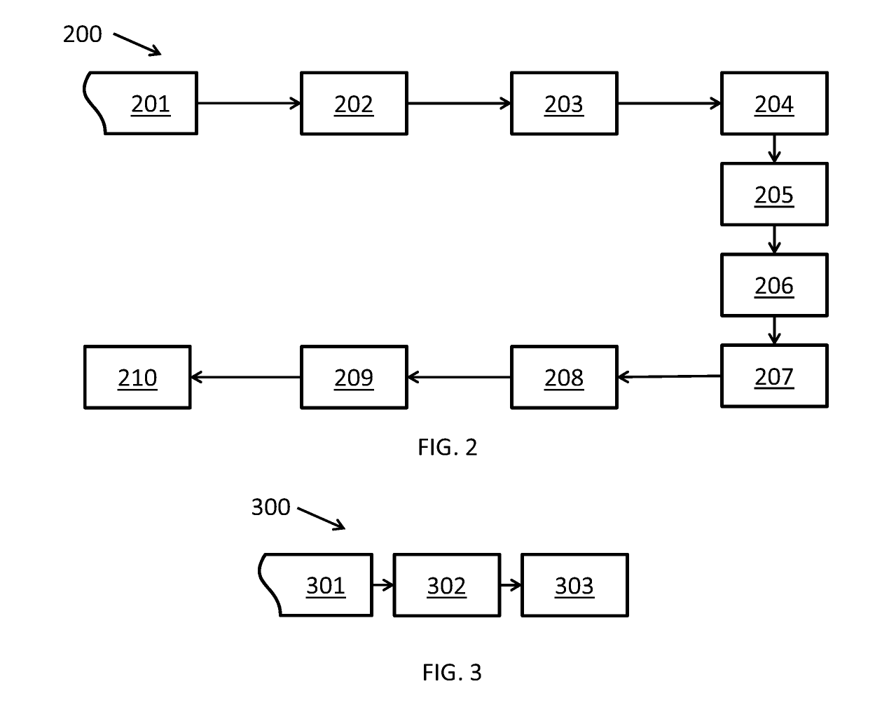

FIG. 2 is a process flow diagram 200 illustrating aspects of a method having one or more features consistent with implementations of the current subject matter. The process 200 may be executed by processor(s) 102 as illustrated in FIG. 1. Some of the elements of process 200 may be executed on a client computing devices 106, external service devices 108, and/or other devices. While the operations are listed separately, the functionality described in the operations may be performed at any one of the operation positions. Where appropriate, the order of the operations is unimportant and is not intended to be limiting. In some implementations of the presently disclosed subject matter, some of the operations may not be performed, while others may be performed only partially.

At 201, client information may be received by the client portal. As used herein, the client portal may refer to the system 100 that is configured to provide the client portal. The client information may be received through a graphical user interface associated with the client portal. The processor(s) 102 may be configured to facilitate presentation of a graphical user interface associated with the client portal. The graphical user interface may be presented to clients through client devices 106. The graphical user interface presented to client users may be an interactive display configured to facilitate the entry and/or selection of information, variables and/or parameters by the client user.

Server 104 and client devices 106 may be in electronic communication through a network 101. Such network may be, for example, the Internet. In some implementations, the network 101 may be a private network or a semi-private network. In some implementations, the network 101 may be a virtual private network. In some implementation, the client information may be received by merging client information from one or more sources with one or more databases associated with the client portal. Such sources may include external sources 108, information provided by clients through client devices 106, information stored on external storage devices 110, information stored within server 104 such as on electronic storage 114, and/or other sources. The client information may include information identifying the client. For example, the client information may include one or more of client name, client description, client logo, client address, billing information, identity of key personnel, client contact information and/or other client information.

The client information may include information associated with client sales campaigns. Client sales campaigns may be associated with products that the client desires to sell. Such client information may include an identification of a client sales campaign, a name for the client sales campaign, a description of the client sales campaign, art work associated with the client sales campaign, product description(s) associated with the client sales campaign, intended sales volume associated with the client sales campaign, the cost of the product, the sale price of the product, lists of actual products and attributes of each, the ability to set geographic restrictions and custom filters, such as those described above, at the campaign or product/sub-category level, an activity log to track changes to the campaign, to track client interactions with sales, and/or other attributes. One or more attributes may be stored in a database associated with the client portal. Such a database may be hosted in electronic storage media associated with the provider of the client portal. The electronic storage media may include in a cloud service. The cloud service may be associated with the client portal provider. The cloud service may lease cloud storage space to the client portal provider.

At 202 the received client information may be normalized. In some implementations, the client portal may be configured to check the spelling of words in the client information. Client information may be cross-referenced with information stored by the client portal provider (such as at server 104), third-party information (such as at external sources 108), and/or other information. Cross-referencing the client information may help correct errors in the information. Cross-referencing the information may help ascertain a confidence level that the information provided is of a certain quality and/or provided by the appropriate entity. The client information may be normalized by ensuring that its format is compatible with formats used in the client portal database.

The client portal may interact with a lead management system to coordinate the management and delivery of leads. Filters and rules created in the client portal may be ported over into lead distribution and/or management algorithms. Client information may be used in real-time, near real-time, and non-real-time in tracking and reporting systems managed and provided by the client portal. The data may also be integrated with sales tools and client relationship management systems. Ad campaign and traffic management tools may access rules created in the client portal to customize media buys. Web content management tools may be used to create custom web properties based on information stored in the client portal.

At 203 the formation of one or more sales campaigns for a client may be facilitated. The one or more sales campaigns for a client may be associated with the received client information. The sales campaigns may comprise the client information, one or more campaign attributes associated with sales leads, one or more campaign rules for associating sales leads with the campaign and/or other information and/or parameters. In some implementations, the one or more sales campaign attributes may include an indication of the one or more separate products offered by the client associated with the sales campaign.

The client portal may include one or more security features to prevent access to the client portal by unauthorized entities. The client portal may have one or more security features to prohibit unauthorized access to one portion of the client portal by an entity having authorization to access another portion of the client portal only. The client portal, or platform, may be configured to grant access to only individuals and/or computer systems that provide correct authentication information. Such authentication information may include a valid username and password. Clients and/or clients of the users may have access to different aspects or features of the client portal. One user of a client may have different access than another user of a client. One client may have different access compared to another client based on subscription information of the client. The client portal may be configured so that certain features of the client portal are accessible only to certain groups. One such group may be administrators). The client portal or platform may be configured to restrict access to certain features, or the platform in its entirety, based on attributes of the accessing computer system. For example, restrictions to the client portal may be based on IP address, or a range of IP addresses, the language associated with a browser used to access the client portal, an operating system used to access the client portal, and/or attributes thereof, and other parameters

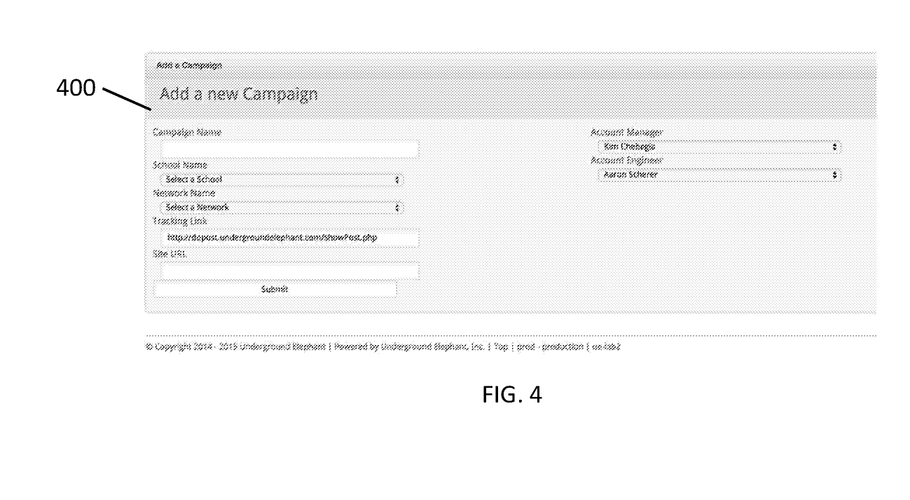

In some implementations, formation of the one or more sales campaigns may be facilitated through a graphical user interface. The sales campaign(s) may be formed by the client, account administrators associated with the client, third-party entities and/or other appropriate entities. FIG. 4 is an illustration of an example of a graphical user interface 400 configured to facilitate the formation of the one or more sales campaigns The graphical user interface 400 configured to facilitate the formation of a sales lead campaign may include one or more fields. The one or more fields may include a campaign name, a client name, an indication of a network associated with the client and/or sales campaign, an indication of a location of an algorithm for tracking sales leads, an indication of the location of a website associated with the sales campaign, an indication of personnel associated with the sales campaign, such personnel being associated with the client and/or provider of the client portal.

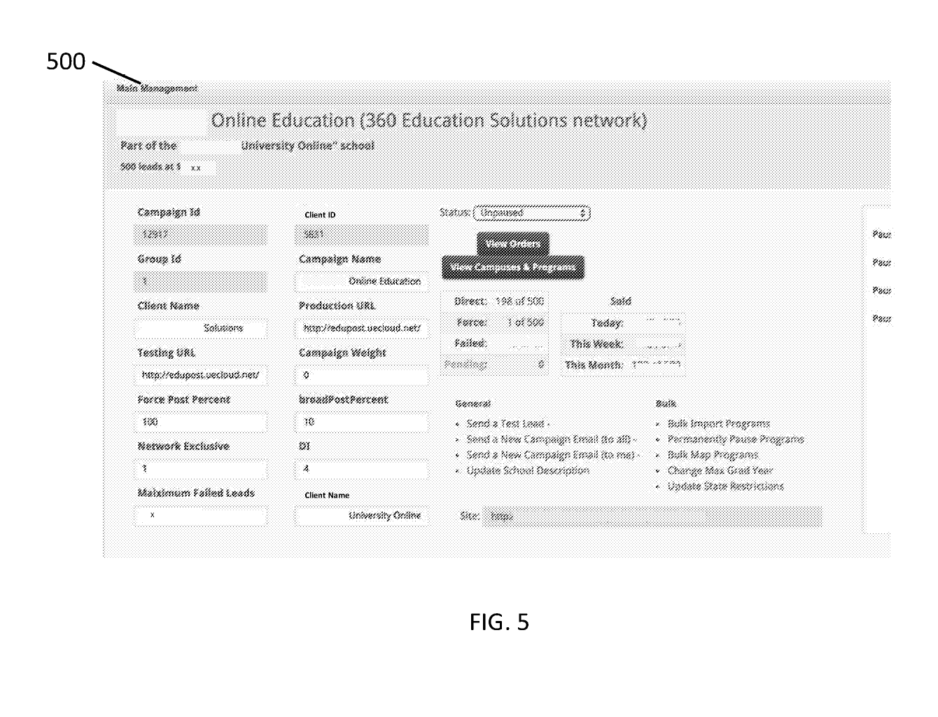

FIG. 5 is an illustration of a graphical user interface 500 configured to facilitate the entry of one or more campaign attributes. The one or more campaign attributes may include one or more of campaign ID, an indication of a campaign group IP, a client name, a location of an Internet location for testing an online sales campaign, indications of one or more metrics associated with the sales leads, a campaign name, an Internet location for an online sales lead campaign, one or more sales campaign metrics (e.g. weight), and/or other campaign attribute information.

In some implementations, the one or more campaign attributes may include sales lead caps. Sales lead caps may provide an indication of a cap to the number of leads that any one sales lead source may provide to the client through the sales lead campaign. Sales lead caps may include an indication of a cap on the number of sales leads that can be transmitted to the client through the sales campaign from all lead sources. Sales lead caps may be time based. For example, the number of sales leads that can be provided during a period of time may be limited to the sales cap.

In some implementations, the sales leads may belong to one or more sales-lead types. The sales types may include real-time, near real-time, non-real-time, exclusive, semi-exclusive, varied types by traffic type/traffic source (for example, traffic from search tools or traffic from social media), call transfers, lead data, call verified leads and/or other sales lead types.

In some implementations, the campaign rules may dictate the types of sales leads that are associated with the campaign. In some implementations, the campaign rules may dictate geographical restrictions on the location of sales leads associated with the campaign. In some implementations campaign rules may be associated with the type of sales lead source, or the medium used to communicate the sales leads. For example, the client portal may control and/or limit the sales leads provided to a client based on the identity of the sales lead provide, the source of the traffic containing the sales leads, a webpage associated with the sales lead source and/or the sales lead.

In some implementations, the campaign rules may be associated with a geographic location. Campaign rules may limit which sales leads are provided to the client through the campaign based on the geographic location of the sales lead. For example, where a campaign is associated with a product that is specific to a particular geographic area, sales leads originating from outside that geographic area may be prohibited from being passed to the client. Such geographic limiting may be facilitated using zip codes, or known location of ISP IP addresses.

Each campaign may be associated with multiple products. Each of the products associated with a campaign may include product-specific rules and/or filters. Each of the products associated with a campaign may include different geographic limitations. The products themselves may be grouped into categories based on one or more attributes of the products.

In some implementations, a mapping tool may be provided that facilitates bulk formation and mapping of campaigns and/or bulk association of products with campaigns.

At 204, sales leads may be associated with one or more sales campaigns for the client.

At 205, sales leads that have been associated with one or more sales campaigns may be scored. The scoring may provide an indication of the likelihood of conversion of that sales lead for a client associated with individual ones of the campaigns. At 205, in response to scoring the sales leads, those sales leads having a score greater than a threshold may be provided to the client. The threshold may be a set threshold, or may be a dynamic threshold.

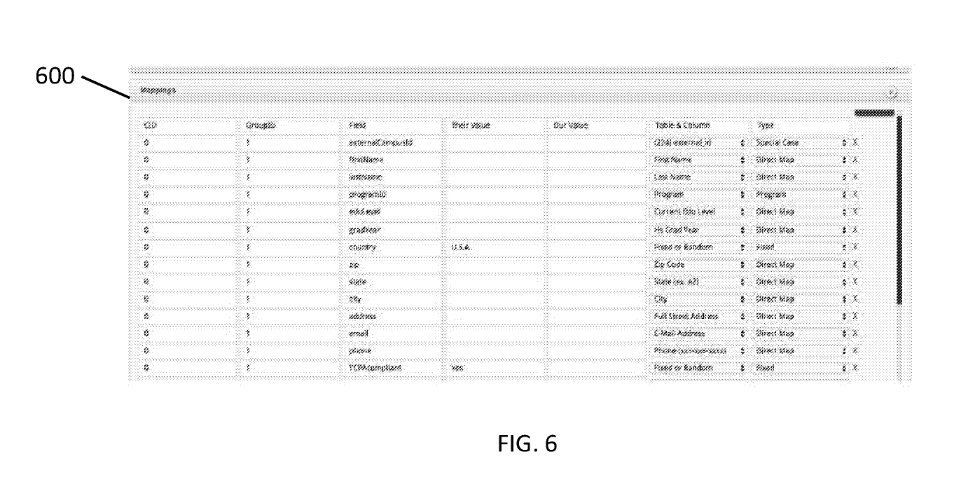

FIG. 6 is an illustration of a graphical user interface 600 configured to facilitate the mapping of sales leads to delivery options by a client. The graphical user interface 500 may be presented to clients through client devices 106. The information associated with the graphical user interface may be processed at server 104 and transmitted to the client computing devices 106 over the network 101. Some of the information associated with the graphical user interface may be processed at the client devices 106. The graphical user interface 600 may include information from a database on electronic storage 110/114 and may include information from a database managed by the client of the client portal and stored in one or more electronic storage devices associated with the client. The graphical user interface 600 may include a number of fields associated with the campaign and/or the client. The graphical user interface 500 may facilitate selection of one or more fields associated with the portal. The graphical user interface 500 may facilitate selection of one or more client-side fields. A user may select one or more of the portal-side fields and choose which client-side field to map the portal-side field to. Once the fields have been mapped, the output of the portal may match with client-side information management systems. In some implementations, the graphical user interface 600 may include a default setting. The default setting may map portal-side fields with client-side fields having the same or similar name and/or format. The user may keep the default selected mapping or may change the mapping as necessary. The graphical user interface 600 may facilitate selection and/or entry of an acceptance of the mapping. In response to an indication of acceptance of the mapping, the client device 106 may be configured to transmit such acceptance and such mapping to the server 104. Such transmission may occur through network 101. Consequently, when sales lead information is processed or transmission to the client, the server 104 may cause the sales lead information to be transmitted in a format consistent with the client's mapping. Alternatively, sales lead information may be transmitted to the client devices 106 and the client devices 106 may be configured by machine readable instructions to reformat the sales lead information to conform with the client's selected mapping.

At 206, sales leads may be monitored. The sales leads may be monitored by system 100. The system 100 may be configured to integrate with the client's sale-side systems and/or itself may facilitate sales. Information providing an identity of a sales lead may be used to determine a sales lead's response to a sales campaign. Such information may be received by the system 100 over a network 100. Sales lead activities associated with the sales campaign, such as viewing the product, interacting with one or more webpages associated with the product, and/or buying the product may be monitored. Such monitoring by the system 100 occurring directly through sales lead interactions with the system, and/or remotely by the system accessing information from the client and/or external sources. In some implementations, those sales leads that accept offers from clients may be monitored. In some implementations, the sales leads associated with one or more sales campaigns may be monitored. In some implementations, the monitoring of sales leads may occur on client devices 106 without oversight by the server 104. The client portal system 100 may provide functionality to the client devices 106 such that the client devices monitor sales lead activity without interference or insight by the provider of the client portal. In this manner, sensitive information may be prohibited from being known outside of the client systems. Sales leads may be posted to client systems. The result of providing sales leads may be monitored to determine if the sales lead was approved, denied, any errors occurred and/or for other information. The monitoring may be configured to detect breakages in the network, or with the way the client side system is integrated. In some variations, data from client systems may be passed back to system 100 in order to monitor the sales cycle of a lead.

At 207, graphical presentation of the proportion of sales leads associated with individual ones of the one or more sales campaigns may be facilitated. Such graphical representations may be facilitated through client computing platforms 106. The graphical representations may be facilitated by execution of computer program instructions by client computing platforms 106 and/or server 104. In some implementations, the graphical presentation of the proportion of sales leads may include the proportion of sales leads associated with a particular sales campaign that have accepted offers from the client associated with the particular sales campaign.

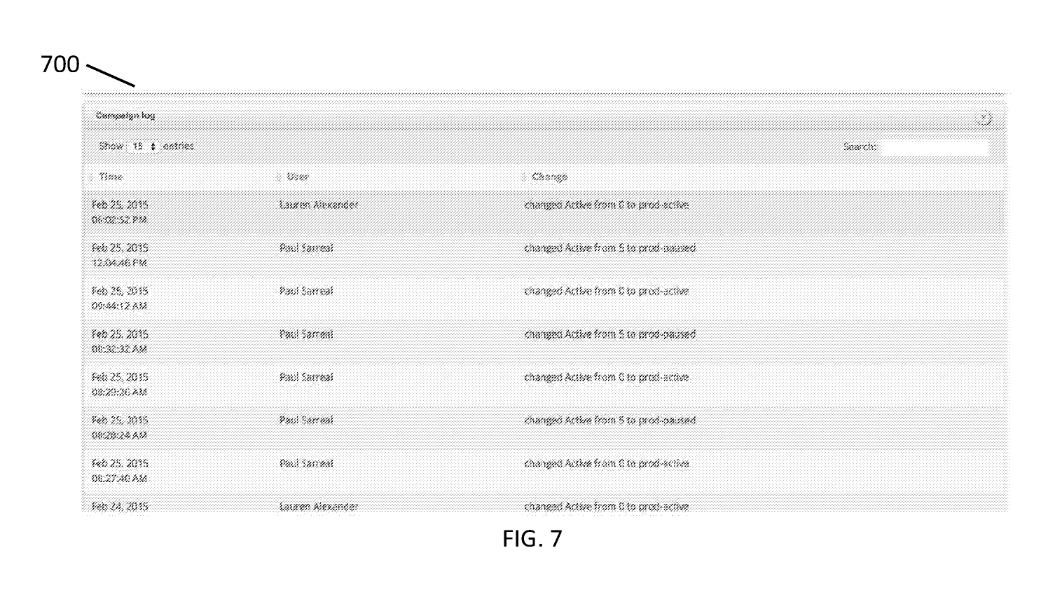

At 208, changes that are made to individual ones of the sales campaigns may be logged. FIG. 7 is an illustration of a sales campaign change log 700. The sales campaign change log 700 may include information associated with each change to the sales campaign. The sales campaign change log 700 may include the data and/or time of the change made to the sales campaign, an identity of the individual who made the change, the type of change, and/or other information associated with the change.

Individual ones of the one or more sales campaigns may include one or more performance parameters. At 209, the performance of the sales campaign may be determined. The performance of the sales campaign may be determined compared to the one or more performance parameters.

At 210, a graphical presentation of the performance of the proportion of sales leads with one or more performance parameters may be facilitated. The graphical presentation may be presented on a graphical user interface.

FIG. 3 is a process flow diagram 300 illustrating aspects of a method having one or more features consistent with implementations of the current subject matter. The process flow diagram 300 illustrates aspects of the operations occurring at 203.

At 301 facilitating formation of an individual one of the one or more sales campaigns for the client comprises facilitating presentation of a graphical user interface providing an indication of one or more potential campaign attributes associated with the sales campaign.

At 202, selection and/or entry of the one or more potential campaign attributes may be selected and/or entered for inclusion in the sales campaign.

At 303, sales leads having sales lead attributes matching the selected and/or entered sales campaign attributes may be matched to the one or more sales campaigns.

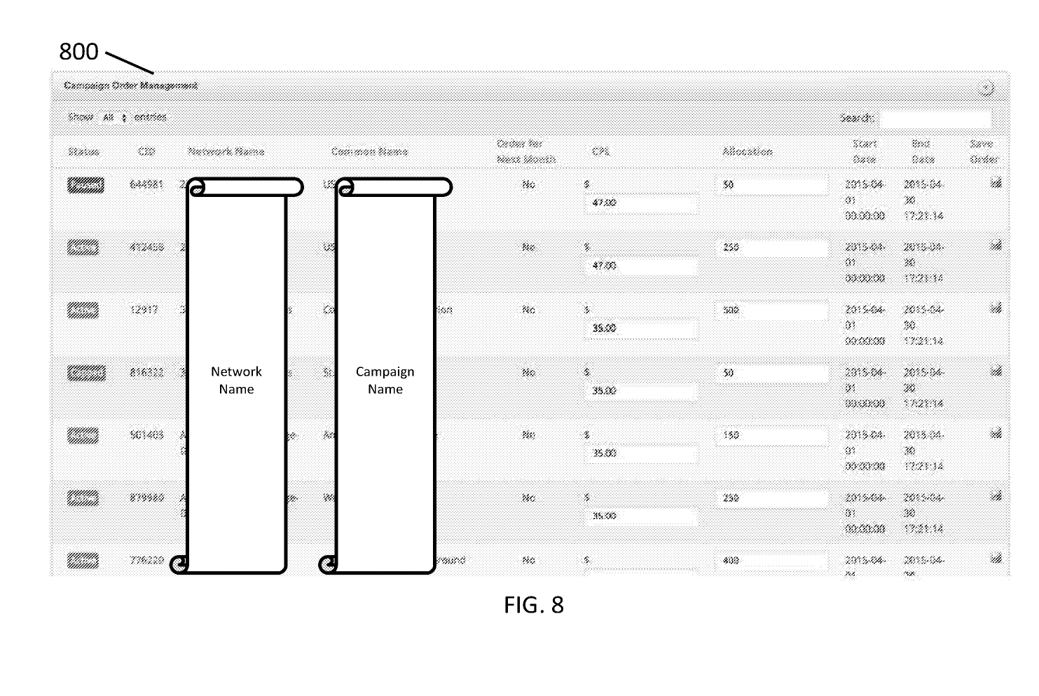

In some implementations, subsequent to a client forming a campaign, the client may desire to make orders based on the formed campaign. FIG. 8 is an illustration of a graphical user interface 800 configured to facilitate, by a client, the placement of an order for sales leads associated with one or more previously formed sales campaigns. In some implementations, the sales campaigns may include a status. The status of the sales campaigns may include one or more of active, inactive, capped, paused, and/or other statuses. An active campaign may include a campaign that is actively providing sales leads to a client. An inactive campaign may include a campaign that is not actively providing sales leads to a client. A paused sales campaign may include a campaign that has been suspended from actively providing sales leads to a client during a period when it is normally active. A capped sales campaign may include a campaign that has a cap on the number of sales leads to provide to the client.

The sales campaigns may be configured to be active during set time periods. For example, a sales campaign may be configured to be active for one week, or for certain periods of the day over a period of time, and/or other time periods. In some implementations, sales leads obtained at one time of day may be superior for certain campaigns, than those obtained at other times of day. For this reason, the active periods of certain campaigns may be limited. The graphical user interface 800 may include an indication of the time periods at which the campaign will be active.

A client having one or more pre-configured sales campaigns may access graphical user interface 800 and provide information to associated with one or more of the pre-configured sales campaigns. The client may enter in a value representing an amount the client is willing to pay for a sales lead. In some implementations, the amount may be paid to a source of a sales lead in response to the client receiving the sales lead, or in response to an indication that the client wishes to receive the sales lead. In other implementations, the amount may be paid to a source of a sales lead in response to the sales lead executing a transaction with the client.

The client may select and/or enter an allocation associated with individual ones of the pre-configured campaigns. The allocation may relate to the number of sales leads that the client wishes to receive from a particular sales campaign. For example, a particular sales campaign may be associated with a particular product that is limited in availability. The client may enter and/or select an appropriate allocation based on the limited availability of the product.

The graphical user interface 800 may provide an indication of a group of campaigns, or network, with which individual campaigns are associated.

The graphical user interface 800 may facilitate selection and/or entry of an acceptance of the one or more parameters selected and/or entered by the client that are associated with the pre-configured campaign. The graphical user interface 800 may be configured to facilitate modification of sales campaigns after activation of the sales campaigns.

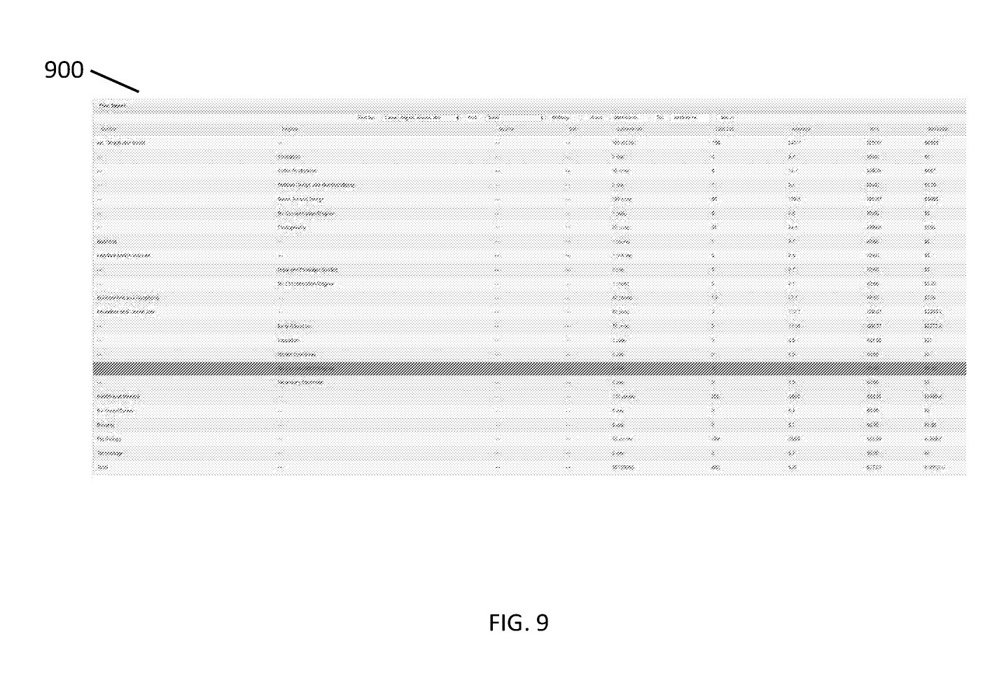

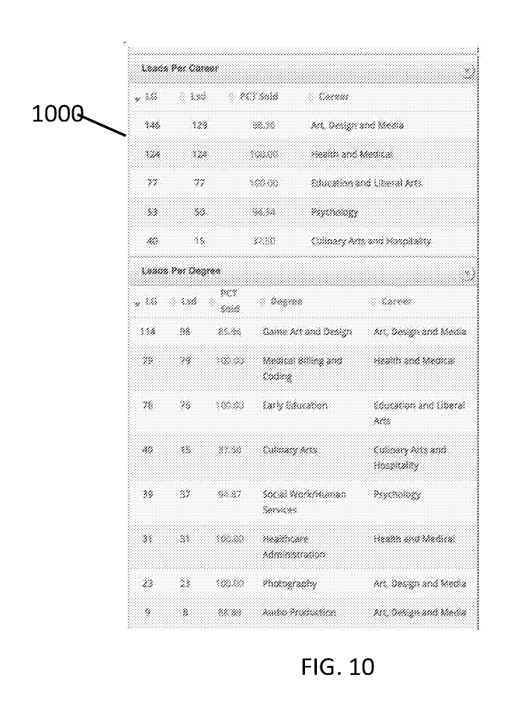

The client portal may be configured to facilitate reporting of one or more key performance indicators associated with the sales campaigns. FIG. 9 is an illustration of a report 900 of one or more key performance indicators associated with one or more sales campaigns. FIG. 10 is an illustration of a report 1000 of one or more key performance indicators associated with one or more sales campaigns. The reports provided by the client portal to the client may include an indication of the lead generation source, lead type and/or other information associated with the sales leads generated through one or more of the sales campaigns. The reports may be configured to arrange the report based on one or more different grouping rules. For example, report 1000 includes a report on the performance of one or more sales campaigns configured to generate sales leads in order to fill university seats. The report 900 may be configured to provide an indication of parameters associated with the sales campaign as arranged by career types that such university placements would tend to lead toward. The report 900 may be configured to provide an indication of parameters associated with the sales campaign as arranged by degree courses. One or more of the degree courses may belong to one or more of the career categories. The report 1000 may include an indication of the number of leads generated, the number leads that accepted the offer by the client, a conversion rate of generated leads to leads who accepted the offer by the client, and/or other parameters. The reports generated by the client portal for client may include an indication of the revenue generated by one or more of the sales campaigns. The reports may break down revenue reports. Such revenue reports may include total revenue, revenue per converted sales lead, revenue per generated sales lead, and/or other revenue information. The reports may include the cost to generate each lead, the cost to generate each dollar of revenue, and/or other information.

The client portal may be configured to provide reports to the provider of the client portal. The reports provided to the provider of the client portal may include sale information, lead generation information, lead data by client, dates at which leads are generated, and/or other information. The client portal may be configured to provide an indication of revenue generated from each client to the provider of the client portal. The client portal may be configured to provide an indication of revenue generated from each client campaign or a group of client campaigns.

Implementations of the current subject matter can provide one or more non-limiting technical advantages including facilitating the creation of sales campaigns to receive sales leads based on interactions between client computing systems and sales lead campaign computing systems.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few implementations have been described in detail above, other modifications or additions are possible. In particular, further features and/or implementations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method to be performed by at least one data processor forming at least part of a computing system, the method comprising:
receiving, by the at least one data processor, client information via a graphical user interface, the client information including one or more client attributes associated with one or more sales leads;
executing, by the at least one data processor, normalizing rules on the received client information to modify the received client information into a format readable by a sales campaign computing system configured to generate a sales campaign for a client associated with the client information;
facilitating, by the at least one data processor, formation of one or more sales campaigns for the client, each the sales campaign comprising:
the client information;
one or more campaign attributes associated with the one or more sales leads, each of the one or more sales leads belonging to one or more sales lead types; and,
one or more campaign rules for associating sales leads with at least one of the one or more sales campaigns;
associating, by the at least one data processor, the one or more sales leads with the one or more sales campaigns for the client according to the one or more campaign rules; and,
generating, by the at least one data processor, a graphical representation of the one or more sales campaigns for presentation to the client through a display device associated with the client.

2. The method in accordance with claim 1, wherein the one or more campaign rules dictate:
the types of sales leads associated with the campaign; and,
geographical restrictions on the location of sales leads associated with the campaign.

3. The method in accordance with claim 1, further comprising:
logging, by the at least one data processor, changes to individual ones of the one or more sales campaigns.

4. The method in accordance with claim 1, further comprising:
monitoring, by the at least one data processor, sales leads associated with individual ones of the one or more sales campaigns that accept offers from the client;
facilitating, by the at least one data processor, generation of a graphical presentation on a graphical user interface, of the proportion of sales leads associated with individual ones of the one or more sales campaigns that have accepted offers from the client.

5. The method in accordance with claim 4, wherein individual ones of the one or more sales campaigns include one or more performance parameters and the method further comprises:
determining, by the at least one data processor, the performance of individual ones of the one or more sales campaigns compared to the one or more performance parameters;
facilitating, by the at least one data processor, generation of a graphical presentation on a graphical user interface, of the performance of individual ones of the one or more sales campaigns compared to the one or more performance parameters.

6. The method in accordance with claim 1, wherein the one or more sales campaign attributes includes an indication of one or more separate products offered by the client.

7. The method in accordance with claim 1, wherein facilitating formation of an individual one of the one or more sales campaigns for the client comprises:
facilitating, by the at least one data processor, presentation of a graphical user interface providing an indication of one or more potential campaign attributes associated with the sales campaign;
facilitating, via the graphical user interface, selection and/or entry of the one or more potential campaign attributes for inclusion in the sales campaign; and,
matching, by the at least one data processor, sales leads having sales lead attributes matching the selected and/or entered sales campaign attributes.

8. A system comprising one or more physical computer processors configured to execute one or more instructions stored on machine-readable media, the one or more instructions causing the one or more physical computer processors to:
receive, by the one or more physical computer processors, client information via a graphical user interface, the client information including one or more client attributes associated with one or more sales leads;
executing, by the one or more physical computer processors, normalizing rules on the received client information to modify the received client information into a format readable by a sales campaign computing system configured to generate a sales campaign for a client associated with the client information;
facilitate, by the one or more physical computer processors, formation of one or more sales campaigns for the client, each sales campaigns comprising:
the client information;
one or more campaign attributes associated with the one or more sales leads, each of the one or more sales leads belonging to one or more sales lead types; and,
one or more campaign rules for associating sales leads with at least one of the one or more sales campaigns;
associate, by the one or more physical computer processors, the one or more sales leads with the one or more sales campaigns for the client according to the one or more campaign rules; and,
generate, by the one or more physical processors, a graphical representation of the one or more sales campaigns for presentation to the client through a display device associated with the client.

9. The system in accordance with claim 8, wherein the one or more campaign rules dictate:
the types of sales leads associated with the campaign; and,
geographical restrictions on the location of sales leads associated with the campaign.

10. The system in accordance with claim 8, where machine-readable instructions are further configured to cause the one or more physical processors to:
log, by the one or more physical processors, changes to individual ones of the one or more sales campaigns.

11. The system in accordance with claim 8, where machine-readable instructions are further configured to cause the one or more physical processors to:
monitor, by the one or more physical processors, sales leads associated with individual ones of the one or more sales campaigns that accept offers from the client;
facilitate, by at least one data processor, generation of a graphical presentation on a graphical user interface, of the proportion of sales leads associated with individual ones of the one or more sales campaigns that have accepted offers from the client.

12. The system in accordance with claim 11, wherein individual ones of the one or more sales campaigns include one or more performance parameters and where machine-readable instructions are further configured to cause the one or more physical processors to:
determine, by the one or more physical processors, the performance of individual ones of the one or more sales campaigns compared to the one or more performance parameters;
facilitate, by the one or more physical processors, a graphical presentation on a graphical user interface, of the performance of individual ones of the one or more sales campaigns compared to the one or more performance parameters.

13. The system in accordance with claim 8, wherein the one or more sales campaign attributes includes an indication of one or more separate products offered by the client.

14. The system in accordance with claim 8, where machine-readable instructions are further configured to cause the one or more physical processors to:
facilitate, by the one or more physical processors, presentation of a graphical user interface providing an indication of one or more potential campaign attributes associated with the sales campaign;
facilitate, via the graphical user interface, selection and/or entry of the one or more potential campaign attributes for inclusion in the sales campaign; and,
match, by one or more physical processors, sales leads having sales lead attributes matching the selected and/or entered sales campaign attributes.
